(19) United States
(12) Patent Application Publication
(10) Pub. No.: US 2009/0072560 A1
(43) Pub. Date: Mar. 19, 2009

(54) Strap configuration and method of use

(76) Inventor: Andrew Tien, Chino Hills, CA (US)

Correspondence Address: PATENT LAW & VENTURE GROUP, 2424 S.E. BRISTOL, SUITE 300, NEWPORT BEACH, CA, 92660, US

(21) Appl. No.: 11/901,801

(22) Filed: Sep. 19, 2007

(51) Int. Cl. B66C 1/18

(52) U.S. Cl. 294/74

(57) ABSTRACT

A strap assembly for lifting a load has a plurality of elongated flexible straps that are joined together and configured in such as way as to enable relatively quick, easy securement of a large object so that it can be safely hoisted. In addition, the present invention discloses a method of hoisting a heavy object, such as an air conditioning unit, into a confined space such as an attic of a home. The strap assembly provides Velcro® type fastening elements enabling the strap assembly to be fitted to a wide range of loads.

### BACKGROUND OF THE INVENTION

1. Field of the Present Disclosure

This disclosure relates generally to hoisting straps and methods for their use in lifting heavy objects, and more particularly to a strap configuration and a method for using the strap configuration in lifting a heavy object into a confined space.

2. Description of Related Art Including Information Disclosed Under 37 CFR 1.97 and 1.98

Dolezych et al, U.S. Pat. No. 4,915,434, discloses an apparatus to shorten and/or fasten flat belts or straps for wrapping and hoisting a load. The apparatus includes a vertical base plate having a crane lug located in its upper portion. Also, at least three deflectors with free ends are mounted in spaced apart relation on the plate so as to project generally perpendicularly therefrom. The free ends of the straps or belts are inserted into the apparatus and pulled between and looped about the deflectors in a meandering fashion to affix the belts to the apparatus before hoisting the load.

Williams, U.S. Pat. No. 7,165,795, discloses a device for use in lifting an air conditioning compressor from an air conditioning unit for servicing or replacement of the compressor. The lifting device is also useful for setting a replacement compressor back into place in an air conditioning unit. It simplifies the task of lifting the compressor by allowing the lifting to be performed at a height that reduces risk of bodily injury and thereby allows the task to be more easily performed. The device is usable by either a single person or by two people if the weight of the particular compressor calls for two people.

The related art described above discloses lifting equipment including lifting straps, hoists and associated mechanical components. However, the prior art fails to disclose a strap assembly and a method of its use that allows an individual, working alone, to raise a heavy object quickly and efficiently and to place the object into a confined space. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

The use of lifting straps to hoist a heavy object, including furnaces and air conditioning units, is commonly known. Often, such loads are installed into attics of homes. This can create a problem when the home has a peaked roof and the entryway into the attic is located in a ceiling area underneath a low point of the roof rafters because there may not be enough room to lift the load high enough to clear the floor of the attic. In addition, attic entryways are typically too narrow to pass many loads lengthwise so that the load must be hoisted with its long dimension held vertically.

In such homes, the process of hoisting the load into an attic space can be hazardous to personnel due to the danger of dropping the load and of straining muscles due to off center lifting due to the limited space, and it can be time consuming, often requiring the labor of two or more persons for several hours. Techniques in common use for such lifting include manhandling the load into the attic space using ladders, and lifting the load from below using jacking devices. Both of these approaches are dangerous, time consuming and expensive. A hoist is usually not used since it further limits the vertical lifting range of the load.

The present invention solves this problem by using a custom strap assembly that is able to secure the load for being lifted by a hoist while overcoming the vertical limitations of such a lift by enabling partial unstrapping to tilt the load while still holding it by the strap and the hoist. Such a strap configuration is able to be quickly and easily employed by wrapping it about the load in a manner that the weight of the load is supported by one of the straps, a lifting strap, and laterally secured on the lifting strap by at least two lateral (belly-band) straps. Quick engagement of the lateral straps around the load is achieved by the use of hook-and-loop (Velcro® type) fastening surfaces on the lateral straps.

To accommodate taller or shorter loads, the vertically oriented lifting strap may also provide hook-and-loop fastening surfaces at its ends so as to enable lengthening or shortening the overall length of the lifting strap while still enabling the formation of loops at its ends for engagement with a hook of a hoisting device.

In addition, the present invention discloses a method of hoisting a load into a confined space such as an attic of a home. It should be noted that the advantages of the present invention are not limited to hoisting loads into confined attic spaces; but rather it can be used to hoist loads with a very broad range of weights and configurations and in the widest possible number of different situations.

A primary objective inherent in the above described apparatus and method of use is to provide advantages not taught by the prior art.

Another objective is to provide a lift strapping apparatus that can be used on a wide range of loads having various shapes and sizes.

A further objective is to provide such a lift strapping apparatus that can secure a large object, quickly, and with relative ease.

A further objective is to provide such a lift strapping apparatus that is relatively lightweight and compact, enabling it to be easily stored and transported when not in use.

A still further objective is to provide such a lift strapping apparatus that reduces the amount of labor and number of persons necessary to hoist a heavy object.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the present invention;

FIG. 2 is a partial side elevational view thereof showing an alternate Y-shaped portion of the strap assembly thereof and a platform attached thereto;

FIG. 3 is a perspective view of the apparatus of FIG. 1 shown engaging a load;

FIG. 4 is a plan view of the apparatus of FIG. 2; and

FIGS. 5, 6 and 7 are elevational views depicting stages of a method, using the presently described apparatus, of vertically lifting a load into a confined space through an opening where the load is tilted to transfer it from the strap assembly to a support surface, including: hoisting the load, as shown in FIG. 5, tilting the load, as shown in FIG. 6, and placing the load, as shown in FIG. 7.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

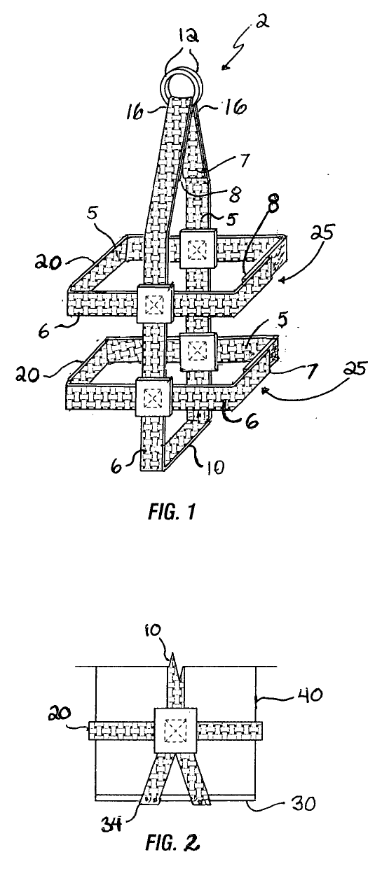

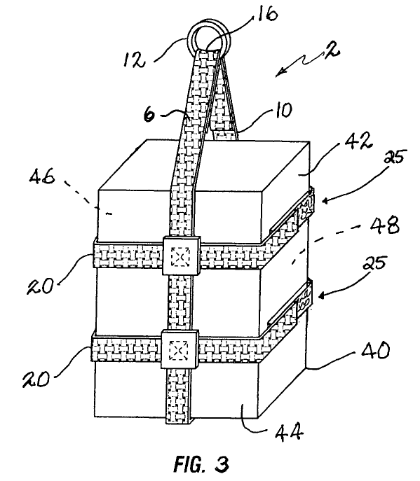

Described now in detail is a lifting strap assembly apparatus for hoisting a heavy load. The strap assembly 2 comprises a plurality of elongated flexible straps, each having opposing flat surfaces 5 and 6 and each terminating at opposing ends 7 and 8 as shown in FIG. 1. One of the straps, herein referred to as a lifting strap 10, provides a closed loop 16 (FIG. 3) at each of its opposing ends 7 and 8. One or more further straps, herein referred to as lateral straps 20, are either permanently or impermanently joined orthogonally at a medial location on the lifting strap 10. When joined impermanently, the lateral straps 20 are joined to lifting strap 10 using hook and loop surface fasteners 25 in one embodiment, so that they are able to be repositioned on lifting strap 10 appropriately for different sized loads. The lateral straps 20 may alternately be permanently joined with the lifting strap 10 using stitching or other methods well known in the art.

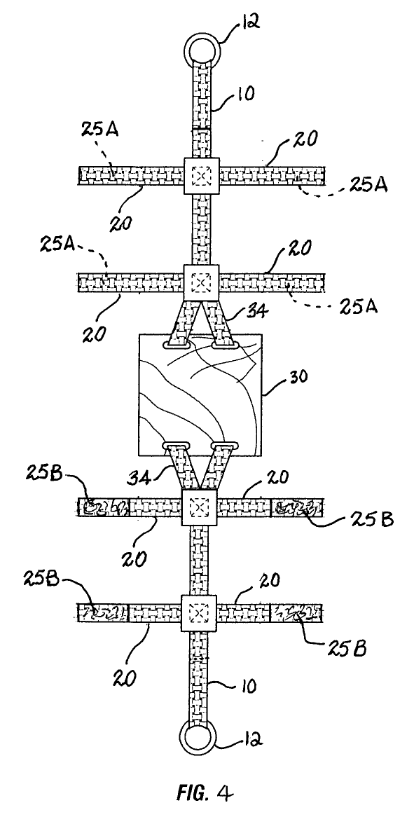

As shown in FIG. 3, each lateral strap 20 provides hook and loop surface fasteners 25, at its opposing ends 7 and 8. However, other suitable types of fasteners, such as threaded hardware, buttons or snaps, may be substituted. In FIG. 4, the surface fasteners 25 are shown and labeled separately as 25A and 25B. This is to help illustrate how the surface fasteners engage with one another. Thus, each surface fastener 25A engages with its corresponding surface fastener 25B on the opposing end of lateral strap 10. In an alternate embodiment, as shown in FIG. 1, the surface fasteners 25 are only located on the lateral straps 20 to one side of the strap assembly 2; while on the other side, the lateral straps 20 are continuous.

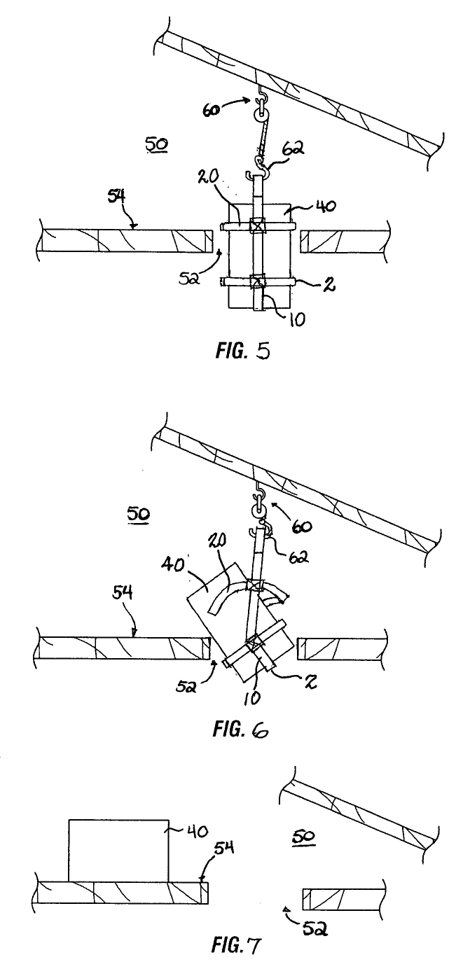

As shown the lifting strap 10 may be formed into a closed loop 16 at its ends by folding its ends 7 and 8 and securing each end against itself using the hook and loop surface fasteners 25. A hoist ring 12 may be secured within loops 16 to improve the ease by which a hoist hook 62 may be engaged with strap 10. Please refer to FIGS. 5 and 6 which, however, do not depict the use of hoist rings 12.

As shown in FIG. 2, a rigid platform 30 may be engaged with the lifting strap 10 so that a load 40 may be stabilized. The platform 30 is preferably made of wood or other relatively lightweight rigid material. In addition, the lifting strap 10 may provide opposing Y-shaped portions 34 for engaging platform 30 with improved stability. In FIG. 4, the platform 30 is permanently engaged with the lifting strap 10.

As shown in FIG. 3, specifically, each lateral strap 20 extends around the load 40, in contact with all four side panels 42, 44, 46 and 48, with the hook and loop surface fasteners 25 positioned on either side panel 42 or 46 or both. As shown, the lifting strap 10 is long enough to vertically encircle the load 40 while positioning its ends 7 and 8 formed as loops 16 somewhere above the load 40, as shown in FIGS. 1 and 3. The lateral strap(s) 20 are fixed to the lifting strap 10 so that with the lifting strap engaged with the load 40, the lateral strap(s) 20 are positionable about the load 40 in a manner to stabilize the load 40 on the lifting strap 10 while joining the ends 7 and 8 of the lateral straps 20 on either one of panels 42 or 46 or both. This arrangement and intersection of orthogonal straps 10 and 20 with a parallelepiped shaped load 40 is then ideally suitable for lifting.

As shown in FIGS. 5-7, the strap assembly 2 is used to vertically lift load 40, typically in conjunction with a hoist 60. In the preferred method of the present invention, the strap assembly 2 is used to lift load 40, through an opening 52 into a confined space 50 such as an attic of a home. As shown in FIG. 5, the load 40 is too long (vertical dimension) to clear the opening 52 before run out of hoist 60. Because of the novel construction of strap assembly 2, the upper lateral strap 20 may be opened while still supporting the load 40 on lifting strap 10 and stabilizing it using the lower lateral strap 20, and the load 40 may be then tilted to one side, as shown in FIG. 5, so as to enable pulling the load 40 onto surface 54 while supporting the full load 40 weight by hoist 60.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

1. An apparatus for hoisting a load comprising:
a strap assembly including an elongate, vertically oriented, looped lifting strap joined with at least one pair of elongate, horizontally oriented, opposing lateral straps, the lateral strap providing mutually engagable surface fasteners at opposing ends thereof;
wherein, with the lifting strap encircling the load, the at least one pair of lateral straps form a horizontally oriented loop with the opposing ends thereof impermanently joined in opposing positions with respect to the load;
whereby, the at least one pair of lateral straps may be disengaged at one of the opposing positions for enabling the load to be tilted toward the disengaged position to transfer the load laterally onto a surface while simultaneously supporting the load within the lifting strap.

2. The apparatus of claim 1 wherein the lateral straps are selectively positionable on the lifting strap, thereby enabling the lateral straps to be repositioned on the lifting strap.

3. The apparatus of claim 1 further comprising a platform engaged with the lifting strap for receiving and supporting the load thereon.

4. The apparatus of claim 3 wherein the lifting strap forms at least one Y-shaped portion for engaging the platform.

5. The apparatus of claim 1 wherein the ends of the lifting strap are fastened as loops.

6. The apparatus of claim 5 wherein the loops are fastened with mutual engagable surface fasteners.

7. A method of vertically hoisting and positioning a load onto a supporting surface in a confined space through an opening, the method comprising the steps of:
encircling the load vertically with a lifting strap engaging ends thereof above the load with a hoist;
encircling the load horizontally with each one of plural lateral straps, each of the lateral straps fastened to the lifting strap on each of opposing sides thereof;
fastening ends of each of the lateral straps distally from the lifting strap;
hoisting the load into the confined space;
disengaging one of the lateral straps and tilting the load toward the disengaged one of the lateral straps;
transferring the load laterally onto the supporting surface while supporting the load in the lifting strap.

8. An apparatus for hoisting a load comprising:
a strap assembly including an elongate, vertically oriented, looped lifting strap engaged with an at least one elongate, horizontally oriented first lateral strap, the at least one first lateral strap, selectively positionable on the lifting strap, providing mutually engagable surface fasteners at opposing ends thereof;
wherein, with the lifting strap encircling the load, each of the at least one first lateral strap forms a horizontally oriented loop for horizontally encircling the load, with the opposing ends of the first lateral strap impermanently joined;
whereby, the at least one first lateral strap is repositionable on the lifting strap for accommodating different sized loads.

9. The apparatus of claim 8 further comprising an at least one elongate, horizontally oriented second lateral strap selectively positionable on the lifting strap and in a position opposing the at least one first lateral strap, wherein, with the lifting strap encircling the load, the at least one pair of first and second lateral straps forms a horizontally oriented loop for horizontally encircling the load, with the opposing ends of the first and second lateral straps impermanently joined in opposing positions with respect to the load.

10. The apparatus of claim 8 further comprising a platform engaged with the lifting strap for receiving and supporting the load thereon.

11. The apparatus of claim 10 wherein the lifting strap forms at least one Y-shaped portion for engaging the platform.

12. The apparatus of claim 8 wherein the ends of the lifting strap are fastened as loops.

13. The apparatus of claim 12 wherein the loops are fastened with mutually engagable surface fasteners.
